(19) United States
(12) Patent Application Publication
(10) Pub. No.: US 2023/0303382 A1
(43) Pub. Date: Sep. 28, 2023

(54) Method for Operating a Filling Device and Respective Filling Device

(71) Applicant: KROHNE Messtechnik GmbH, Duisburg (DE)

(72) Inventors: Dirk Kuschnerus, Krefeld (DE); Christopher Lüke, Gelsenkirchen (DE); Sven Walbrecker, Wurster Nordseekuste (DE)

(21) Appl. No.: 18/189,931

(22) Filed: Mar. 24, 2023

(30) Foreign Application Priority Data
Mar. 25, 2022 (DE) 10 2022 107 097.2

(51) Int. Cl. B67D 1/12; B67D 1/08; G05D 7/06; G05B 19/416

(52) U.S. Cl. CPC B67D 1/1243; B67D 1/0888; G05D 7/0623; G05B 19/416; G05B 2219/45006

(57) ABSTRACT

A method is described and shown for operating a filling device with a filling valve for controlling a medium flow, with a discrete-time sampling flow sensor for measurement-based capture of the medium flow discharged by the filling valve and with a controller for actuating the filling valve, wherein the control unit controls the filling valve to perform a filling process with a defined target filling quantity, taking into account the measured actual filling quantity, which is determined with the aid of the flow measurement values captured by the flow sensor. A measurement error caused by the discrete-time sampling of the flow measurement is reduced by synchronizing the start of the filling process between the filling valve and the flow sensor so that the first sampled flow measurement value of the flow sensor has a defined time relationship to the initial opening of the filling valve during the filling process.

### TECHNICAL FIELD

The invention relates to a method for operating a filling device, having a filling valve for controlling a medium flow, having a discrete-time sampling flow sensor for measurement-based detection of the medium flow discharged by the filling valve, and having a controller for actuating the filling valve, wherein the controller actuates the filling valve to perform a filling operation with a defined desired filling amount, taking into account the actual filling amount, which is determined with the aid of the flow measurement values detected by the flow sensor. The invention further relates to a filling device of the same type.

### BACKGROUND

Filling devices of the aforementioned type are widely used in process technology, for example in the chemical industry, but especially in the food and beverage industry. Devices based on quite different measuring principles are used as flowmeters; magnetic-inductive flowmeters are frequently used, which have the advantage that no mechanically moving parts are required to perform a measurement, unlike, for example, vortex flowmeters or Coriolis mass flowmeters. Industrially used process engineering filling systems often have a large number of the previously described filling devices, which could also be referred to as filling stations within a filling system.

Regardless of the measuring principle, the flow sensors typically implement a sampling system that captures and outputs a measured value at discrete points in time and does not provide a measured value continuously in time—for example, by means of an analog signal. This is often due to the digital signal processing within the flow sensor alone, in the course of which an analog/digital conversion of the (processed) raw measuring signals is carried out, resulting in automatic sampling.

The filling device described above comprises a filling valve, a flow sensor and a control unit. The filling valve can be technically implemented in various ways, it can be a valve with a single controllable actuator, but it can also comprise several controllable components, for example a combination of switching valve and control valve. The control unit controls the filling valve, wherein this control is actually mostly based on closed-loop control. The controlled variable, i.e. the filling amount, is captured by continuously integrating the sampled flow measurement values during a filling process, so that at any time the filling amount, i.e. the measured actual filling amount, is known and—as is typical for a control process—compared with the specified desired filling amount. The filling valve is then controlled as a function of the control difference, for example by adjusting the degree of opening of the filling valve.

Apart from the fact that it is always desirable to dose a medium as accurately as possible as part of a filling process, the accuracy of a filling process is of increased importance when filling into containers intended for passing on to end consumers (bottles, canisters, cans). Here, a minimum amount, usually the amount indicated on the container, must be guaranteed to be contained, so that tolerances in filling are always at the expense of the manufacturer, i.e. overfilling is always used. This sometimes also gives rise to technical problems, for example when filled media escape from the container into which they are filled and contaminate the container from the outside, which can happen in particular with foaming media.

### SUMMARY

It is an object of the present invention to design and further develop the method for operating the filling device and a corresponding filling device in such a way that the filling process can be performed with increased accuracy.

The previously derived and demonstrated object is achieved by the method for operating a filling device in that the start of the filling process is synchronized between the filling valve and the flow sensor, so that the first sampled flow measurement value of the flow sensor has a defined temporal relationship to the initial opening of the filling valve during the filling process.

The underlying finding of the invention is that the error in the flow measurement, or in the determination of the actual filling amount based on the measured values of the flow measurement, is subject to a fluctuation that depends on how far—understood in terms of time—the first sampled flow measurement value is away from the actual flow present. Due to sampling, the flow sensor may be “blind” for the maximum time of a sampling period. If, in the worst case, the medium flow starts exactly after a sampling period has just passed, the medium flow will remain undetected and thus unconsidered for the duration of a sampling period. The error becomes smaller the closer the nearest sampling time is to the time of the onset of the medium flow. The design of the method according to the invention establishes a defined temporal relationship between the initial opening of the filling valve—and thus the onset of the medium flow—and the triggering of the capture of the first sampled flow measurement value. In this sense, then, “synchronized” is to be understood as meaning that the start of the filling process is synchronized between the filling valve and the flow sensor: Thus, this does not mean exactly at the same time, but in a suitable time dependence on each other. As a result, the scatter of the measurement error can be suppressed in any case, and furthermore the magnitude of the measurement error can also be reduced and even minimized.

In a further development of the method, it is provided that the first sampled flow measurement value of the flow sensor lies temporally with respect to the initial opening of the filling valve in such a way that the flow measurement value is captured as close as possible in time to the initial opening of the filling valve. This approach also has the effect of eliminating or at least greatly reducing the scatter of the flow measurement value caused by the sampling of the flow measurement value. The measure can be implemented relatively easily.

The minimization of the measurement error is aimed at by a preferred design of the method, which is characterized in that the first sampled flow measurement value of the flow sensor is performed temporally to the initial opening of the filling valve in such a way that the flow measurement value is captured as close as possible to the lower measuring range limit of the flow sensor. This minimizes the time period in which the flow sensor does not record a flow measurement value due to the time discrete manner of the measurement, in which the flow sensor is “blind”—as described above.

In a further development of the above method, it is provided that the first sampled flow measurement value is determined with a defined time delay with respect to the initial opening of the filling valve, in particular taking into account a system-related dead time between a change in the actuation of the filling valve and a change in the medium flow at the location of the flow measurement by the flow sensor. This could be the case, for example, if, viewed in the direction of flow of the medium, the filling valve is arranged upstream of the flow sensor.

The object derived above is also achieved in a filling device with a filling valve for controlling a medium flow, with a discrete-time sampling flow sensor for measurement-based detection of the medium flow discharged by the filling valve, and with a controller for actuating the filling valve, wherein the controller actuates the filling valve to perform a filling operation with a defined desired filling quantity, taking into account the actual filling amount, which is determined with the aid of the flow measurement values captured by the flow sensor, namely in that a synchronization means triggers the start of the filling operation in a synchronized manner between the filling valve and the flow sensor, so that the first sampled flow measurement value of the flow sensor is in a defined temporal relationship to the initial opening of the filling valve during the filling operation. As in the previously illustrated method, the initial opening of the filling valve means the opening of the filling valve triggering the filling process.

For the filling device, the previously presented further developments of the method for operating a filling device naturally also represent further developments of the filling device.

In a first preferred design of the filling device, it is provided that the synchronization means is implemented by synchronous local clocks in the filling valve and the flow measurement sensor, wherein the control unit transmits commands to the filling valve and the flow measurement sensor for triggering the initial opening of the filling valve and for triggering the capture of the first sampled flow measurement value. The commands each contain execution times for performing the command. The fill valve and the flow sensor perform the commands when the transmitted execution times coincide with the respective time of the synchronous local clock. The filling to valve and the flow sensor only need to receive the commands sufficiently far in advance of the respective execution times so that the commands can also be safely performed at the transmitted execution time.

Which temporal relationship or which temporal offset between triggering the opening of the filling valve and triggering the capture of the first sampled flow measurement value is most suitable for generating the lowest possible measurement error can be determined automatically by the filling device without further ado by means of an appropriate test run. If the process conditions remain the same, which they usually do—within certain limits—then the filling operations will be, if not nearly identical, then very similar. Thus, different time shifts between triggering the initial opening of the filling valve and triggering the capture of the first sampled flow measurement value could be systematically tested, wherein the most appropriate time shift is the one at which the smallest flow measurement values above the measurement threshold are regularly determined.

In an alternatively designed preferred filling device, it is provided that the synchronization means is implemented by a time-deterministic bus system between the control unit, the filling valve and the flow sensor, wherein the control unit transmits commands to the filling valve and the flow sensor for triggering the initial opening of the filling valve and for triggering the capture of the first sampled flow measurement value, and wherein commands determined in terms of time are performed immediately by the filling valve and the flow sensor following receipt by the filling valve and the flow sensor.

A time deterministic bus communication is usually based on time slices assigned to the individual bus participants for their communication (transmission) and a previously well-defined scheduling of the bus communication, in which causality, maximum response times, etc. are taken into account. Examples of standardized buses of this type include real-time Ethernet, ARCNET, FlexRay, and TTP.

Another design of the filling device is characterized in that the synchronization means is implemented by at least a first communication link between the control unit and the filling valve or the control unit and the flow sensor, and by a second communication link between the filling valve and the flow sensor. A command to trigger the filling process is transmitted to the filling valve or the flow sensor by the control unit via the first communication link. The filling valve receiving the trigger command or the flow sensor receiving the trigger command synchronizes the initial opening of the filling valve or the determination of the first sampled flow measurement value via the second communication link. Here, a local second communication link is used, which could also be referred to as a “trigger line”. A suitable timing offset may be pre-registered on the device receiving the trigger signal, so that the desired timing is implemented.

In another preferred design of the filling device, it is provided that the synchronization means is implemented by a state variable sensor that captures a state variable of the filling device, and by a communication link through which the state variable sensor at least indirectly communicates the captured state variable to the filling valve and/or the flow sensor, wherein the filling valve and/or the flow sensor evaluate the transmitted state variable and, depending on the evaluation, locally trigger the initial opening of the filling valve and/or the capture of the first sampled flow measurement value of the flow sensor. The state variable of the filling device could, for example, be position information of the containers to be filled that are transported in the filling system. In the case of containers transported on a conveyor belt, this would therefore be the conveyor belt position; if the containers are transported on a transport carousel in order to reach the filling device, the position information could correspondingly be a rotation angle of the transport carousel.

An advantageous design of the filling device is characterized in that the elements of the filling device, i.e., control unit, flow sensor and filling valve, are integrated in a housing and/or wherein the control unit, the electronic components of the flow sensor, i.e., essentially the signal processing of the raw measurement data supplied by the flow sensor and, if applicable, a communication interface, and the electronic components of the filling valve, i.e., essentially power electronic components for controlling the filling valve and, if applicable, also a communication interface, are implemented on a circuit board. The resulting close interconnection of the electronic components structurally ensures that fast communication between the components is possible, since components of a technical implementation that would be necessary if the electronic components were performed separately and arranged remotely, for example a field bus system with its inherent latencies, are not required.

### BRIEF DESCRIPTION OF THE DRAWINGS

In detail, there are now a large number of possibilities for designing and further developing the method for operating a filling device according to the invention and the filling device according to the invention. For this purpose, reference is made to the following description of embodiments in conjunction with the drawings.

FIG. 1 schematically illustrates a method for operating a filling device together with such a filling device as known from the prior art.

FIG. 2 schematically illustrates the relationships between the control or the degree of opening of a filling valve and the actual filling amount as well as the measured filling amount in the case of a discrete-time sampling flow sensor.

FIG. 3 schematically illustrates the procedure according to the invention for synchronized operation of the filling valve and flow sensor to reduce error dispersion.

FIG. 4 schematically illustrates the procedure according to the invention of the synchronized operation of filling valve and flow sensor to reduce the error dispersion and to reduce a filling error.

FIG. 5 schematically illustrates the method of operating a filling device according to the invention and a corresponding filling device with synchronized operation between filling valve and flow sensor.

FIG. 6 schematically illustrates the method according to the invention and the filling device according to the invention using real-time clocks.

FIG. 7 schematically illustrates the method according to the invention and the filling device according to the invention using a time-deterministic bus system.

FIG. 8 schematically illustrates the method according to the invention and the filling device according to the invention with a communication link between the filling valve and the flow sensor.

FIG. 9 schematically illustrates the method according to the invention and the filling device according to the invention using a state variable of the filling device or involved components of the filling device.

### DETAILED DESCRIPTION

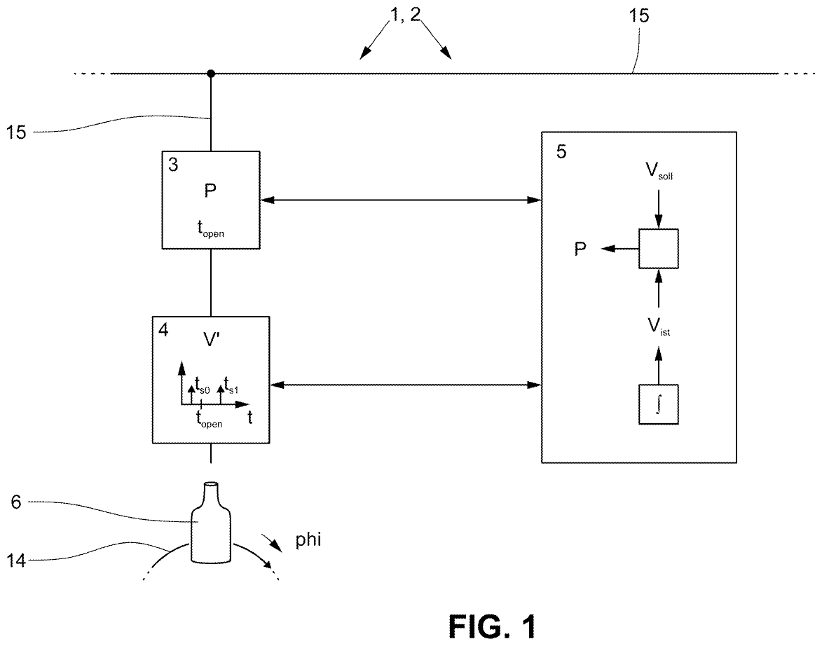

The figures show a method 1 for operating a filling device 2 and also the corresponding filling device 2. In each case, the filling device 2 comprises a filling valve 3 for controlling a medium flow, a discrete-time sampling flow sensor 4 for measurement-based capture of the medium flow V′ discharged by the filling valve 3, and a controller 5 for actuating the filling valve 3. The filling device 2 is connected to a medium line 15 via which the filling device 2 is supplied with the medium to be filled. The control unit 5 controls the filling valve 3 in order to actually dispense a defined desired filling amount Vsoll into a container 6 when performing the filling process, as shown in FIG. 1. For this purpose, the measured actual filling amount Vist is determined with the aid of the flow measurement values V captured by the flow sensor 4. If the captured flow measurement values V are, for example, volume flows, i.e. volume throughput per time, then these values are integrated discretely in time to form the measured—and calculated—actual filling amount Vist. A control difference is usually formed from the measured actual filling amount Vist and the desired filling amount Vsoll, and (using a suitable controller) a manipulated variable for the degree of opening P of the filling valve 3 is calculated and output to the filling valve 3. This approach, i.e. the construction of a control loop for performing the filling process, is usually necessary because the medium flow V discharged by the filling valve 3 depends not only on the opening position of the filling valve 3, but also, for example, on the medium pressure prevailing on the inlet side of the filling valve 3, which may well fluctuate in a process engineering system.

The illustration in FIG. 1 is also schematic in that two separate communication connections are shown, one between the control unit 5 and the filling valve 3, and another between the control unit 5 and the flow sensor 4. However, this is not important; the connections are to be understood as functional. What is important is that there is an exchange of information between the filling valve 3, the flow sensor 4 and the control unit 5 to the required extent. This information exchange could also be implemented with a serial bus between the components, so that the control unit 5 only needs a single communication interface.

Like all technical measuring systems, the filling device 2 shown here also has a measuring error which can be minimized within certain limits, for example, by calibrating the filling device 2.

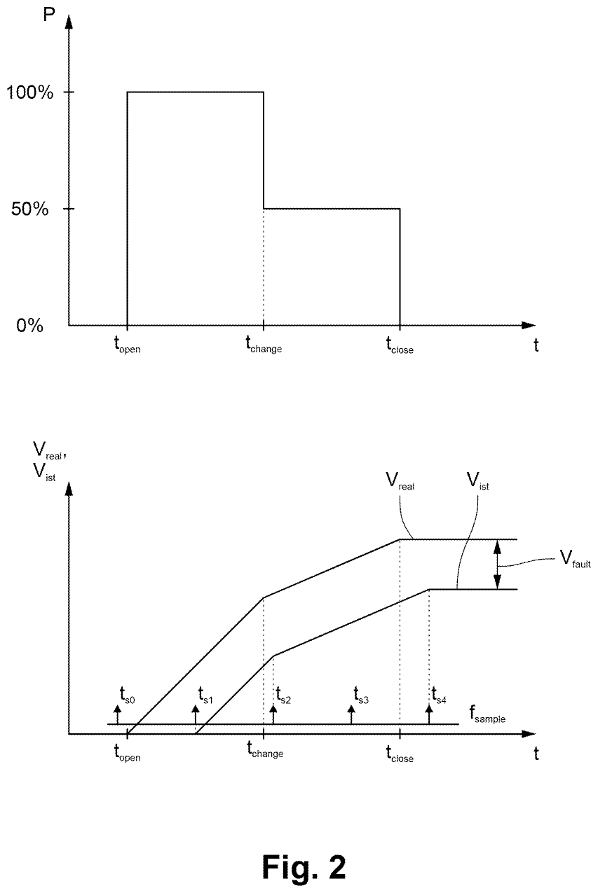

The invention is based on the knowledge that the use of the discrete-time sampling flow sensor 4 is accompanied by a methodological error which cannot be eliminated even by calibration. To explain this circumstance, FIG. 2, above, shows in a diagram the temporal course of the degree of opening P of the filling valve 3 schematically over time. Up to a point in time topen the filling valve 3 is completely closed, then it is completely opened and at a point in time tchange it is half closed, and finally at the point in time tclose it is completely closed again, the filling process is finished here.

In FIG. 2, below, the curves of filling amounts are shown. The curve course denoted by Vreal indicates the actual filling amount, i.e. not falsified by any measuring error, which is delivered by the filling valve 3. The curve course denoted by Vist represents the actual filling amount captured and therefore measured by the sampling flow sensor 4. Furthermore, the sampling function fsample is shown above the time axis with sampling times ts0, ts1, ts2 etc. equidistantly spaced in time. At each of these sampling times, the discrete-time sampling flow sensor 4 determines a flow measurement value. Note that the individual flow measurement values are not shown here, but only the time integral over the flow measurement values in the form of the actual error-free filling amount Vreal and the measured actual filling amount Vist.

It can be seen clearly that the zeroth sampling time ts0 is shortly before the time topen of the initial opening of the filling valve 3. However, the volume flow starts with the opening of the filling valve 3 at the time topen, is not determined by the discrete-time sampling flow sensor 4, but is detected for the first time at the sampling time ts1. In the time before that, the flow sensor 4 has been “blind” with regard to the actual medium flow V′. The volume flow V′ between the time topen of the initially opening filling valve 3 and the capture of the first sampled flow measurement value of the flow sensor 4 at time ts1 is therefore actually missing in the measurement-based capture of the discharged medium flow V′. After completion of the filling process at time tclose, an error Vfault thus finally occurs in the flow measurement, which is related to the discrete-time sampling flow sensor 4.

The illustration in FIG. 2 is schematic and chosen to clearly show the underlying effect. It is obvious that the observed sampling-induced error has a particular significance when the time duration of the filling process itself is in the range of a few sampling steps ts. The more sampling steps ts the filling process lasts, the more insignificant is the error made at the beginning in case of a large distance of the first sampled flow measurement value of the flow sensor 4 at the time ts1 with a flow measurement value not equal to zero from the time topen of the initial opening of the filling valve 3. In industrial filling processes, the unfavorable case of filling processes lasting only a short time is quite often given, when filling processes are, for example, in the range of seconds or even less. An equally important problem is not only the fact that a measurement error is associated with the discrete-time measurement, but also the scattering of the measurement error, which results in that, in the general case, the sampling function fsample is shifted differently at the times fopen, fchange and fclose for each filling process.

The idea for—to a large extent—avoiding these systematic errors caused by the time-discrete operation of the flow sensor 4 (filling error per se as well as fluctuation of the filling error) is that the start of the filling process is synchronized between the filling valve 3 and the flow sensor 4, so that the first sampled ts1 flow measurement value of the flow sensor 4 has a defined time relationship to the initial opening topen of the filling valve 3 during the filling process. The sampling function fsample thus always has the same time relationship to the filling process and thus to the times topen, tchange and tclose.

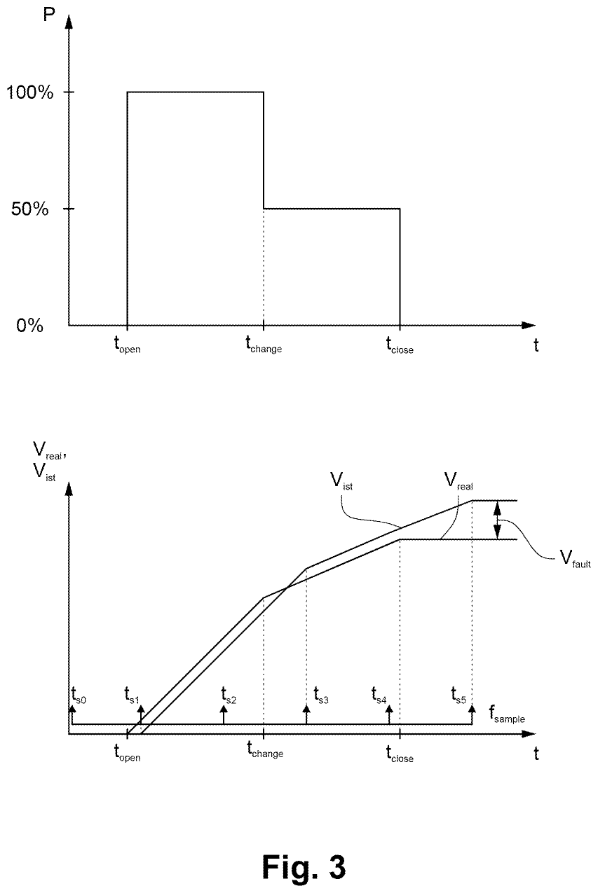

The idea described above is illustrated in principle in FIG. 3. In FIG. 3, at the top, the degree of opening P of the filling valve 3 is again shown; the representation does not differ in the course from FIG. 2. In FIG. 3, at the bottom, the requirement is now taken into account that the start of the filling process is synchronized between the filling valve 3 and the flow sensor 4 in such a way that the first sampled flow measurement value of the flow sensor 4 at the time ts1 has a defined time relationship to the initial opening of the filling valve 3 at the time topen during the filling process. This greatly limits the fluctuation range of the error made. The time synchronization is performed here with the proviso that the first sampled ts1 flow measurement value of the flow sensor 4 is performed with a time relation to the initial opening topen of the filling valve 3 such that the flow measurement value is captured as close as possible to the lower measuring range limit of the flow sensor 4. This can be seen in FIG. 3 below, because compared to the illustration in FIG. 2, here the time ts1 of the first sampled flow measurement value of the flow sensor 4 has moved closer to the time topen of the initial opening of the filling valve 3, so that the time range in which the flow sensor 4 is blind to an already existing medium flow V is minimized. It can be seen that the error Vfault in the flow measurement is recognizably smaller here than in the example in FIG. 2.

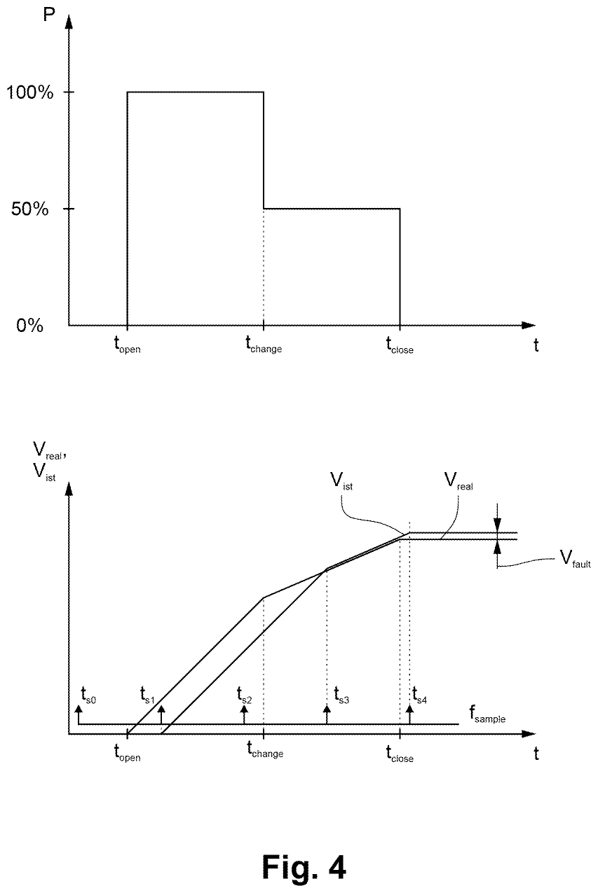

The previously indicated design rules as to how the sampling function fsample should preferably be arranged at the filling times, in particular how the first sampled flow measurement value of the flow sensor 4 at the time ts1 should behave with respect to the initial opening of the filling valve 3 at the time topen (as close as possible or as close as possible to the lower measuring range limit), ensure in any case that the fluctuation range of the measurement error is eliminated as far as possible, but it does not necessarily minimize the absolute measurement error in this way. Within the scope of the invention, it has been recognized that the measurement error that arises is not only at the beginning of the measurement, when the first sampling time ts1 and the opening of the filling valve at the time topen diverge, but at every point in the filling process at which the filling process changes, i.e., when the degree of opening P of the filling valve changes, and the change is only perceived with a time delay due to the sampling. This situation is clearly illustrated by FIG. 4. Here, the first sampling time ts1 and the opening of the filling valve 3 at the time topen are further apart than in FIG. 4, but the resulting measurement error Vfault is nevertheless smaller than in FIG. 3.

In a preferred design of the method, it is therefore provided that the first sampled flow measurement value of the flow sensor 4 at time ts1 is in a defined temporal relationship to the initial opening of the filling valve 3 at time topen during the filling process in such a way that the filling error is minimized. The time offset required for this between the time ts1 of the first sampled flow measurement value and the time topen of the opening of the filling valve 3 can be determined in different ways. One possibility is to perform a series of measurements with different temporal offsets and then select the temporal tuning that has the smallest error. Another possibility consists in a purely theoretical consideration, for example on the basis of a graphical representation as in FIGS. 2 to 4, with which a time offset can be determined at which the measurement error is small or even minimal.

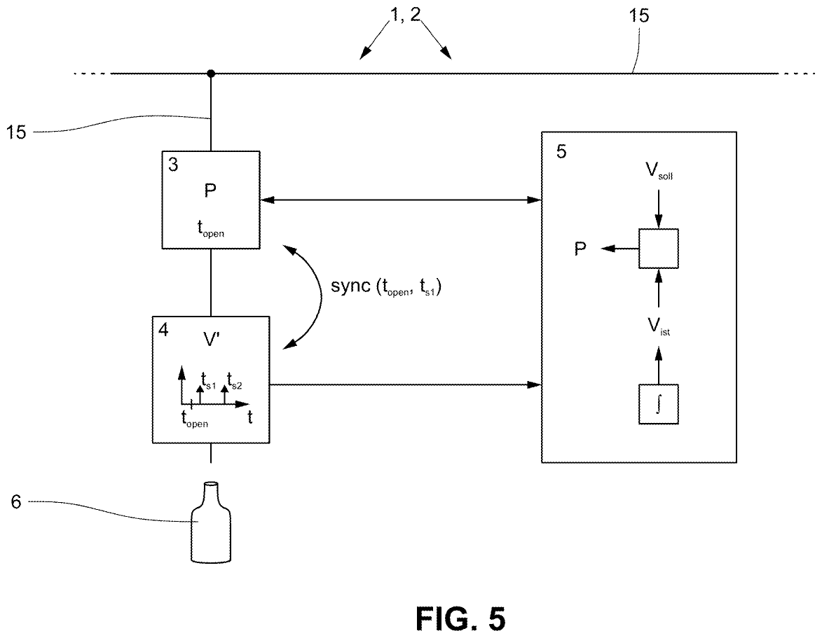

The described principle of operation of the filling device 2 is shown again in an objective equivalent in FIG. 5. In contrast to FIG. 1, here the start of the filling process is performed synchronized sync(topen, ts1) between the filling valve 3 and the flow sensor 4, i.e. in temporal coordination with each other. In the synchronization sync, it is specifically provided that the first sampled flow measurement value of the flow sensor 4 at time ts1 is performed temporally to the initial opening of the filling valve 3 at time topen such that the flow measurement value is captured as close as possible to the lower measurement range limit of the flow sensor 4. This is a technical criterion that ensures that the earliest possible, technically reasonable detection time is selected.

There are various technical possibilities for implementing the required synchronization sync between filling valve 3 and flow sensor 4. For this purpose, a synchronization means 7 is generally provided, which triggers the start of the filling process in a synchronized manner between filling valve 3 and flow sensor 4, so that the first sampled ts1 flow measurement value of flow sensor 4 is in a defined temporal relationship to the initial opening topen of the filling valve 3 during the filling process.

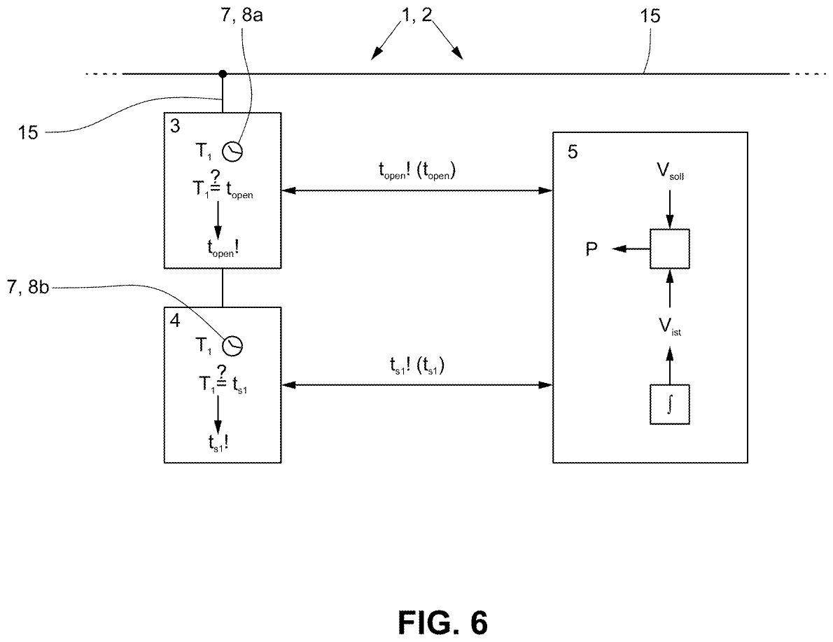

In the filling device 2 according to FIG. 6, it is provided that the synchronization means 7 is implemented by synchronous local clocks 8a, 8b in the filling valve 3 and the flow sensor 4. Both local synchronous clocks show the time T1. The control unit 5 sends commands topen! and ts1! to the filling valve 3 and the flow sensor 4 for triggering the initial opening of the filling valve 3 and for triggering the capture of the first sampled flow measurement value, wherein the commands topen! and ts1! respectively contain execution times topen, ts1 for the execution of the respective command topen!, ts1! The filling valve 3 and the flow sensor 4 perform the commands when the execution times topen, ts1 coincide with the respective time T1 of the synchronous local clock 8a, 8b.

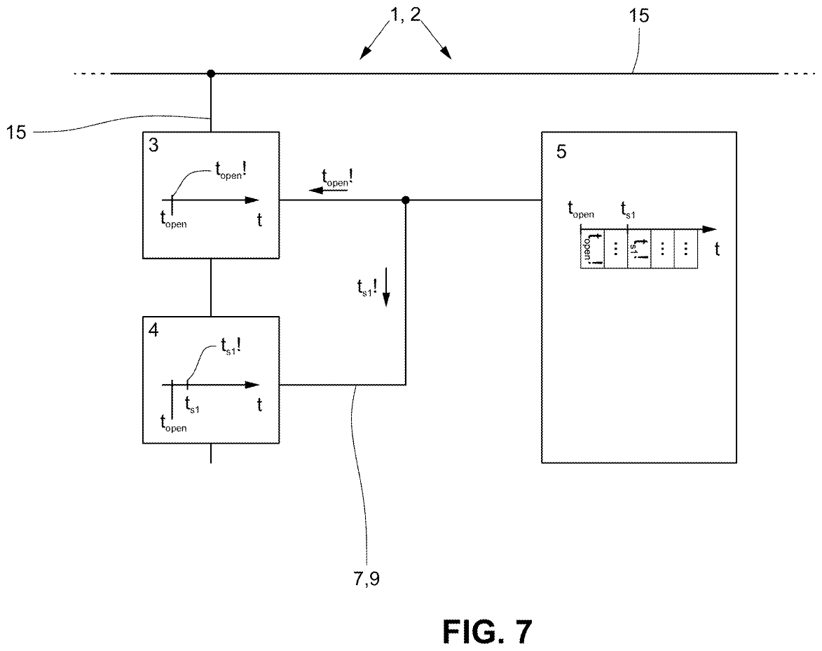

The filling device 2 according to FIG. 7 shows an alternative implementation of the synchronization means 7. The solution consists in the use of a time-deterministic bus system 9 between the control unit 5, the filling valve 3 and the flow sensor 4. The control unit 5 sends commands topen!, ts1! to the filling valve 3 and the flow sensor 4 to trigger the initial opening of the filling valve 3 and to trigger the capture of the first sampled flow measurement value. In the control unit 5, the time-deterministic communication plan for the members of the time-deterministic bus system 9 is shown schematically. Due to the fact that each bus member receives defined time slices for its communication, there can be no problems with colliding bus messages and arbitration of the time deterministic bus system 9, which is why a deterministic communication behavior is guaranteed. The time deterministic transmitted commands topen! and ts! are performed immediately by the filling valve 3 and the flow sensor 4 after reception by the filling valve 3 and the flow sensor. In this way, it is also achieved here that during the filling process the first sampled ts1 flow measurement value of the flow sensor 4 and the initial opening topen of the filling valve 3 are in a defined temporal relationship.

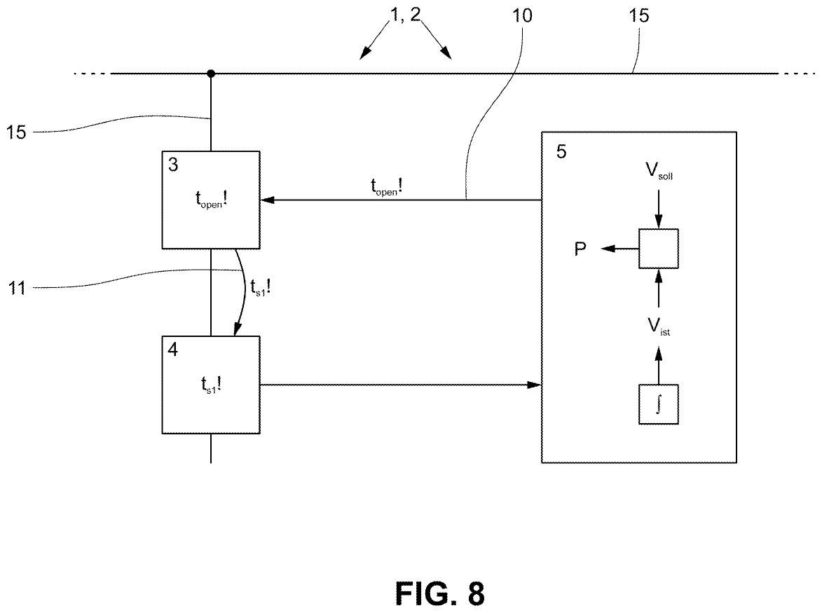

Another alternative design of the synchronization means 7 is shown in the filling device 2 in FIG. 8. The filling device 2 shown here is characterized in that the synchronization means 7 is implemented by a first communication link 10 between the control unit 5 and the filling valve 3 and by a second communication link 11 between the filling valve 3 and the flow sensor 4. A command to trigger topen! the filling process is transmitted to the filling valve 3 by the control unit 5 via the first communication link 10. The filling valve 3 receiving the triggering command topen! synchronizes the initial opening topen! of the filling valve 3 and the determination ts1! of the first sampled flow measurement value via the second communication link 11 by transmitting the command ts1! for capturing the first sampled flow measurement value to the flow sensor 4 via the second communication link 11.

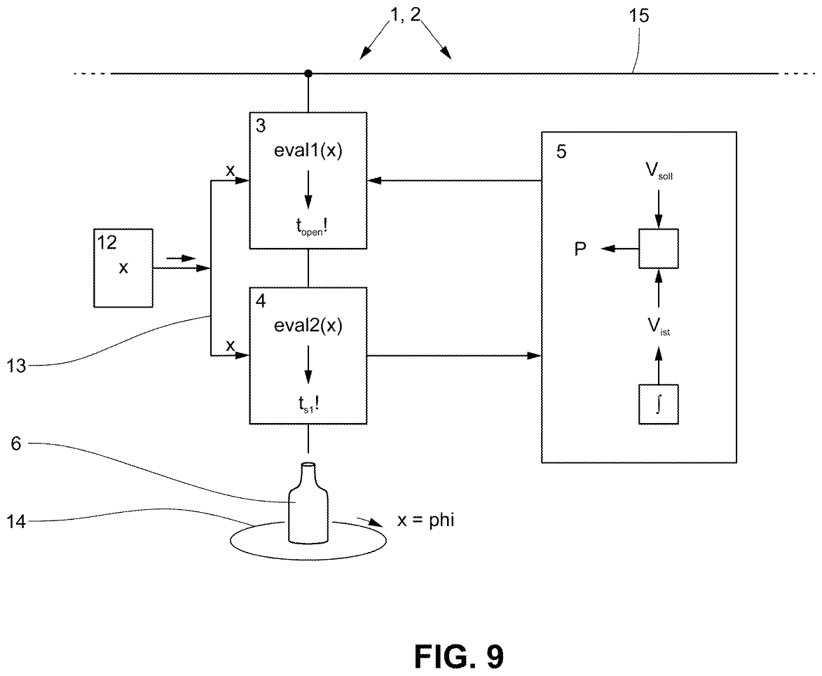

FIG. 9 shows another design of the filling device 2. In this filling device 2, it is provided that the synchronizing means 7 is implemented by a state variable sensor 12, which captures a state variable x of the filling device 2, and transmits it to the filling valve 3 and the flow sensor 4 through a communication link 13. The filling valve 3 and the flow sensor 4 evaluate the transmitted state variable x from eval1, eval2, and depending on the evaluation eval1, eval2, the initial opening topen of the filling valve 3 and the capture of the first sampled ts1 flow measurement value of the flow sensor 4 are triggered locally. In FIG. 8, the state variable sensor 12 is a position sensor which indirectly captures the position of the container 6 to be filled as a state variable x of the filling device 2 by detecting the rotation angle phi of the transport carousel 14.

A design of the filling device 2 not shown here provides that the state variable x is transmitted to the control unit 5, the control unit 5 evaluates the state variable x eval1, eval2 and transmits corresponding control commands topen!, ts1! to the filling valve 3 and the flow sensor 4, where they are then performed.

1. A method for operating a filling device having a filling valve for controlling a medium flow, having a discrete-time sampling flow sensor for measurement-based capture of the medium flow discharged by the filling valve, and having a controller for actuating the filling valve, wherein the control unit controls the filling valve to perform a filling operation with a defined desired filling amount, taking into account the measured actual filling amount, which is determined with the aid of flow measurement values captured by the flow sensor, the method comprising:
synchronizing the start of the filling process between the filling valve and the flow sensor, so that a first sampled flow measurement value of the flow sensor is in a defined temporal relationship to an initial opening of the filling valve during the filling process.

2. The method according to claim 1, wherein the first sampled flow measurement value of the flow sensor is performed temporally to the initial opening of the filling valve in such a way that the flow measurement value is captured as close as possible in time to the initial opening of the filling valve.

3. The method according to claim 1, wherein the first sampled flow measurement value of the flow sensor is performed temporally to the initial opening of the filling valve in such a way that the flow measurement value is captured as close as possible to the lower measuring range limit of the flow sensor.

4. The method according to claim 1, wherein the first sampled flow measurement value is determined with a defined time delay relative to the initial opening of the filling valve taking into account a system-related dead time between a change in the actuation of the filling valve and a change in the medium flow at the location of the flow measurement by the flow sensor.

5. The method according to claim 1, wherein the first sampled flow measurement value of the flow sensor at the time is related in time to the initial opening of the filling valve at the time to pen in the filling process such that the filling error is minimized.

6. A filling device, comprising:
a filling valve for controlling a medium flow;
a discrete-time sampling flow sensor for measurement-based capture of the medium flow discharged by the filling valve; and
a controller for actuating the filling valve;
wherein the control unit controls the filling valve to perform a filling operation with a defined desired filling amount, taking into account the measured actual filling amount, which is determined with the aid of the flow measurement values captured by the flow sensor; and
wherein a synchronization mean triggers the start of the filling process in a synchronized manner between the filling valve and the flow sensor, so that the first sampled flow measurement value of the flow sensor is in a defined temporal relationship to the initial opening of the filling valve during the filling process.

7. The filling device according to claim 6, wherein the synchronizing means is designed in such a way that at least one of:
the first sampled flow measurement value of the flow sensor is performed temporally to the initial opening of the filling valve in such a way that the flow measurement value is captured as close as possible in time to the initial opening of the filling valve;
the first sampled flow measurement value of the flow sensor is performed temporally to the initial opening of the filling valve in such a way that the flow measurement value is captured as close as possible to the lower measuring range limit of the flow sensor; and
the first sampled flow measurement value is determined with a defined time delay relative to the initial opening of the filling valve taking into account a system-related dead time between a change in the actuation of the filling valve and a change in the medium flow at the location of the flow measurement by the flow sensor.

8. The filling device according to claim 6, wherein the synchronization means is implemented by synchronous local clocks in the filling valve and the flow sensor:
wherein the control unit sends commands for triggering the initial opening of the filling valve and for triggering the capture of the first sampled flow measurement value;
wherein the commands each contain execution times for performing the command; and
wherein the filling valve and the flow sensor perform the commands when the execution times coincide with the respective time of the synchronous local clock.

9. The filling device according to claim 6, wherein the synchronization means is implemented by a time-deterministic bus system between the control unit, the filling valve and the flow sensor; and
wherein the control unit transmits commands to the filling valve and the flow sensor for triggering the initial opening of the filling valve and for triggering the capture of the first sampled flow measurement value, and the commands transmitted determined by time are performed immediately by the filling valve and the flow sensor after receipt by the filling valve and the flow sensor.

10. The filling device according to claim 6, wherein the synchronization means is implemented by at least a first communication link between the control unit and the filling valve or the control unit and the flow sensor and by a second communication link between the filling valve and the flow sensor;
wherein a command for triggering the filling process is transmitted to the filling valve or the flow sensor by the control unit via the first communication link, and
wherein the filling valve receiving the triggering command or the flow sensor receiving the trigger command; synchronizes the initial opening of the filling valve and the determination of the first sampled flow measurement value via the second communication link.

11. The filling device according to claim 6, wherein the synchronization means is implemented by a state variable sensor, which captures a state variable of the filling device, and by a communication link, via which the state variable sensor at least indirectly communicates the captured state variable to the filling valve and/or the flow sensor; and
wherein the filling valve and/or the flow sensor evaluates the transmitted state variable and, depending on the evaluation, locally triggers the initial opening of the filling valve and/or the capture of the first sampled flow measurement value of the flow sensor.

12. The filling device according to claim 11, wherein the state variable sensor is a position sensor which captures the position of the container to be filled or the conveying position of a conveyor belt or the angle of rotation of a transport carousel as state variable of the filling device.

13. The filling device according to claim 6, wherein the control unit, the flow sensor and the filling valve are integrated in a housing and/or the control unit, electronic components of the flow sensor and electronic components of the filling valve are implemented on a printed circuit board.
